(19) United States
(12) Patent Application Publication
(10) Pub. No.: US 2026/0094601 A1
(43) Pub. Date: Apr. 2, 2026

(54) METHOD, SYSTEM AND MEDIUM FOR RECOGNIZING PANIC BEHAVIOR BASED ON PANIC SEMANTIC ANALYSIS

(71) Applicant: Tongji University, Shanghai (CN)

(72) Inventors: Rongyong Zhao, Shanghai (CN); Bingyu Wei, Shanghai (CN); Cuiling Li, Shanghai (CN); Yuxin Cai, Shanghai (CN); Chuanfeng Han, Shanghai (CN); Hao Zhang, Shanghai (CN); Yunlong Ma, Shanghai (CN)

(21) Appl. No.: 19/182,851

(22) Filed: Apr. 18, 2025

Related U.S. Application Data
(63) Continuation of application No. PCT/CN2025/085578, filed on Mar. 28, 2025.

(30) Foreign Application Priority Data
Sep. 29, 2024 (CN) 2024113704567

(51) Int. Cl. G10L 15/18; G10L 15/08; G10L 25/63

(52) U.S. Cl. CPC G10L 15/1815; G10L 25/63; G10L 2015/088

(57) ABSTRACT

A method for recognizing panic behavior based on panic semantic analysis includes: calling an AI interface to recognize audio streaming as semantic information in real-time, and performing, based on the semantic information and a basic concept, layered division to recognize key phrases; determining a specific layer and a position of each key phrase according to a position coordinate matrix; and obtaining a weight of each key phrase according to the specific layer and position using a description matrix, and performing consistency matching on a panic degree in a scene to determine whether the panic behavior occurs. Establishment steps of the panic semantic reasoning network model include: selecting a panic scene as a description object; defining a basic concept in the panic scene by using OWL; supplementing knowledge elements in the panic scene to improve the panic semantic model; and defining reasoning rules to establish the panic semantic reasoning network model.

### TECHNICAL FIELD

The disclosure relates to the field of panic behavior recognition, and more particularly to a method, a system and a medium for recognizing panic behavior based on panic semantic analysis.

### BACKGROUND

Since 2022, countries around the world have successively entered the post pandemic era of lifting social lockdowns. Various public places are hosting an increasing number of crowd-gathering activities (such as transportation, religion, sports, commerce, culture, and entertainment), making the assurance of crowd stability particularly crucial. Pedestrian panic behavior is an important factor affecting crowd stability. How to recognize pedestrian panic behavior is of great significance to the scientific control and emergency evacuation of crowds in public places. At present, the recognition of panic behavior mainly focuses on the recognition of abnormal pedestrian postures. For complex group scenes, there is relatively little research on panic behavior recognition methods through a panic semantic reasoning network model.

Current research exhibits several limitations, as outlined below. (1) At present, most of the research on panic behavior recognition focuses on the recognition of abnormal pedestrian postures, and there are few related studies on recognizing panic scenes through a panic semantic model. (2) The panic scenes are diverse, and knowledge elements of different panic scenes have different weights in the recognition process of the panic scenes, which will bring certain obstacles to the recognition of the panic scenes. However, there are few studies on eliminating this obstacle to improve the accuracy of panic scene recognition.

### SUMMARY

An objective of the disclosure is to provide a method, a system and a medium for recognizing panic behavior based on panic semantic analysis to overcome the defects in the related art, to thereby improve the accuracy for recognizing the panic behavior.

The objective of the disclosure can be achieved through the following technical solutions.

A method for recognizing panic behavior based on panic semantic analysis, includes:
calling an artificial intelligence (AI) interface to recognize audio streaming as semantic information in real-time, and performing, based on the semantic information and a basic concept, layered division to recognize key phrases in the semantic information;
determining a specific layer and a position of each of the key phrases in a panic semantic model according to a position coordinate matrix; and
obtaining a weight of each of the key phrases according to the specific layer and the position of each of the key phrases using a description matrix of a panic semantic reasoning network model, and performing consistency matching on a panic degree in a scene to determine whether the panic behavior occurs in the scene;
where establishment steps of the panic semantic reasoning network model include:
selecting a panic scene as a description object;
defining a basic concept in the panic scene by using a web ontology language;
supplementing knowledge elements in the panic scene to improve a panic semantic model in the panic scene; and
defining, based on the panic semantic model in the panic scene, reasoning rules to establish the panic semantic reasoning network model with a panic semantic analysis ability and a panic event reasoning ability.

In an exemplary embodiment, the method for recognizing panic behavior based on panic semantic analysis further includes:
in response to the panic behavior occurs in the scene, sending alerts through broadcasting to alert people around the scene, sending a warning message to people around the scene through a mobile phone, and notifying security personnel go to the scene for handling.

In an embodiment, the semantic information includes shouting, cries for help and conversation content in crowds.

In an embodiment, the panic scene includes medical disturbance scenes, natural disaster scenes and crowded scenes.

In an embodiment, the knowledge elements in the panic scene include the key phrases, crowd statuses and occurrence conditions.

In an embodiment, the position coordinate matrix is expressed as follows:

$$A = \{ {a}_{( q + 1 ) \times {col}_{r}} \} = \{ \begin{matrix}i , j , … , z , r \\ i , j , … , z , r + 1 \\ ⋮ \\ i , j , … , z , r + q\end{matrix} \} = \{ \begin{matrix}{A}_{0} \\ {A}_{1} \\ ⋮ \\ {A}_{q}\end{matrix} \} ;$$

where i=colᵣ−1, colᵣ represents a total length of each of the key phrases, Aᵢ represents key phrases that have a same total length but are different in a last layer, q+1 represents a total number of keywords in a layer where each of the key phrases is located.

In an embodiment, the description matrix of the panic semantic reasoning network model is expressed as follows:

$$M = \{ {m}_{i , j} \} = \{ \begin{matrix}{m}_{{A}_{0}} & {ω}_{{A}_{1}} \\ {m}_{{A}_{1}} & {ω}_{{A}_{2}} \\ ⋮ & ⋮ \\ {m}_{{A}_{q - 1}} & {ω}_{{A}_{q - 1}} \\ {m}_{{A}_{q}} & {ω}_{{A}_{q}}\end{matrix} \} ;$$

where m_{A}_{_{q}} represents position information of a (q+1)^{th} key phrase in a q^{th} layer, ω_{A}_{_{q}} represents a weight of the (q+1)^{th} key phrase in the q^{th} layer, and

$${\sum }_{1}^{q} {ω}_{{A}_{q}} = 1.$$

In an embodiment, the description matrix includes key phrase information and weight information.

In an embodiment, when the panic semantic reasoning network model matches with key phrases related to panic and a weighted structure exceeds a threshold, a matching result of the panic semantic reasoning network model is γ=1; otherwise, γ=0.

According to another aspect of the disclosure, a non-transitory computer-readable storage medium is provided, the non-transitory computer-readable storage medium is stored with a computer program, and the computer program is configured to, when is executed by a processor, implement the method for recognizing the panic behavior based on panic semantic analysis.

According to another aspect of the disclosure, a system for recognizing panic behavior based on panic semantic analysis is provided, including a key phrase recognition module, a layered position module, and a panic behavior determination model.

The key phrase recognition module is configured to call an AI interface to recognize audio streaming as semantic information in real-time, and perform, based on the semantic information and a basic concept, layered division to recognize key phrases in the semantic information.

The layered position module is configured to determine a specific layer and a position of each of the key phrases in a panic semantic model according to a position coordinate matrix.

The panic behavior determination model is configured to obtain a weight of each of the key phrases according to the specific layer and the position of each of the key phrases using a description matrix of a panic semantic reasoning network model, and perform consistency matching on a panic degree in a scene to determine whether the panic behavior occurs in the scene.

### Establishment Steps of the Panic Semantic Reasoning Network Model Include:

selecting a panic scene as a description object;
defining a basic concept in the panic scene by using a web ontology language;
supplementing knowledge elements in the panic scene to improve a panic semantic model in the panic scene; and
defining, based on the panic semantic model in the panic scene, reasoning rules to establish the panic semantic reasoning network model with a panic semantic analysis ability and a panic event reasoning ability.
   Compared with the Related Art, the Disclosure has the Following Beneficial Effects.
1. The disclosure determines whether panic events such as disaster events and terrorist attacks occur in the scene and gives a warning through real-time speech recognition when the panic behavior occurs, which can effectively avoid the occurrence of the panic behavior, and increase the accuracy for recognizing the panic behavior of pedestrians at the same time.
2. The disclosure performs layered division through key semantic information and the basic concepts, and greatly reduces the performance requirements of the computer for key phrase recognition through the layered design structure, and enhances the immediacy of key phrase detection.
3. The disclosure optimizes the weights through statistical methods, which can accurately recognize whether the panic behavior occurs in the scene, and can determine other panic scenes by changing the weights of the key phrases, and also provide new ideas for subsequent research on crowd stability analysis and avoiding the spread of the panic behavior.

### BRIEF DESCRIPTION OF DRAWINGS

FIG. 1 illustrates a schematic flowchart of a method for recognizing panic behavior based on panic semantic analysis according to an embodiment of the disclosure.

FIG. 2 illustrates a schematic structural diagram of a panic semantic reasoning network model according to an embodiment of the disclosure.

FIG. 3 illustrates a schematic derivation logic diagram of a description matrix of the panic semantic reasoning network model according to an embodiment of the disclosure.

### DETAILED DESCRIPTION OF EMBODIMENTS

The disclosure will be described in detail in conjunction with drawings and embodiments. The embodiments are implemented based on the technical solution of the disclosure, and provide a detailed implementation method and a specific operation process, but a protection scope of the disclosure is not limited to the following embodiments.

### Embodiment 1

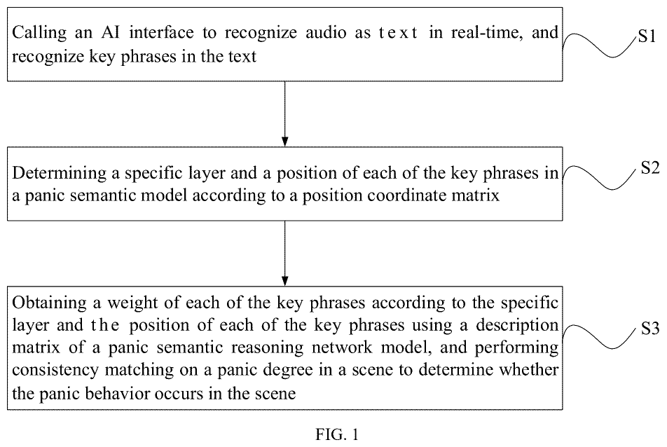

The embodiment provides a method for recognizing a panic behavior based on panic semantic analysis, as shown in FIG. 1, including the following steps S1-S3.

In S1, an AI interface is called to recognize audio streaming as semantic information in real-time, and layered division is performed based on the semantic information and a basic concept to recognize key phrases in the semantic information.

The embodiment takes the 2022 Ruijin Hospital injury event as an example, uses Ruijin Hospital injury videos, and verifies a panic semantic reasoning network model through the real panic event video. The video records the panic events that occurred in Ruijin Hospital due to injuries, including crowd chaos, cries for help, and panic behavior.

The audio from the Ruijin Hospital injury event video is called to Baidu® AI interface to achieve the conversion from speech to text, capture and recognize semantic information such as shouting, cries for help, and conversation content in the crowds. The semantic information is input into the panic semantic reasoning network model. In the text obtained by speech recognition, the panic semantic reasoning network model recognizes key phrases related to the panic scene, and the key phrases include “chop people”, “help”, “run quickly”, and “someone is injured”.

The layered division is performed through the semantic information and the basic concepts, with longer key semantic information having a higher layer where a first field is located. Specifically, the basic concept typically involves understanding common behaviors, language patterns and emotional expressions in a scene. The main rule of the layered division is to assign each recognized phrase to a predefined layer based on the semantic content, context, and situation in the speech. These layers are usually clearly defined in the original database of the panic semantic model and include different categories such as emotions, behaviors, and scenes. Each phrase, such as “pay for life” and “save life”, is classified into a corresponding layer, such as “medical disturbance event” or “crowded stampede event”, based on its meaning. The panic semantic model will determine the specific location of the phrase based on the context and emotional intensity of the speech, and infer and judge the occurrence of panic behavior through these layers. For example, in “I want to kill” and “kill”, the computer retrieves the semantic information word by word (recognized from the first character). Assuming that “I want to kill” is positioned, “I” will first be positioned in an i^{th} layer, “want to” will be searched in an (i+1)^{th} layer, and then “kill” will be searched in an (i+2)^{th} layer. The position of “kill” will be directly positioned in the (i+2)^{th} layer, and the previous layers will be filled with 0 as a position code. Certainly, due to different initial positioning information, the impact of “I want to kill” and “kill” on whether panic behavior occurs in the scene will also be different. It is found that this design structure can significantly reduce the performance requirements of computers and enhance real-time detection. When the computer recognizes potential key phrases, when subsequent fields do not match, they are considered non key phrases, such as “I want to cat” which is not considered key semantic information.

In S2, a specific layer and a position of each of the key phrases in a panic semantic model is determined according to a position coordinate matrix.

Specifically, the panic semantic model is a model constructed based on the semantic understanding of behavior and emotions in a crowd. It mainly determines an individual's panic state by analyzing and recognizing semantic information related to panic behavior. Specifically, the panic semantic model relies on the fusion analysis of multidimensional data such as voice and language in the crowd, and converts audio streams into semantic information through speech recognition technology (such as speech to text), and then classifies and reasons behaviors based on this information. This model is trained by using a large amount of labeled panic and non-panic data. The machine learning, deep learning, and other techniques are combined, and the model is continuously optimized, so that the model can more accurately determine and recognize panic behavior in different scenes. The core goal of the model is to extract and analyze semantic information to determine whether an individual is in a state of panic, and to recognize the phenomenon of panic propagation in real-time within the crowd.

The position coordinate matrix is expressed as follows:

$$A = \{ {a}_{( q + 1 ) \times {col}_{r}} \} = \{ \begin{matrix}i , j , … , z , r \\ i , j , … , z , r + 1 \\ ⋮ \\ i , j , … , z , r + q\end{matrix} \} = \{ \begin{matrix}{A}_{0} \\ {A}_{1} \\ ⋮ \\ {A}_{q}\end{matrix} \} ;$$

where i=colᵣ−1, colᵣ represents a total length of each key phrase, Aᵢ represents key phrases that have a same total length but are different in a last layer, q+1 represents a total number of keywords in the layer where the key phrase is located, i is a row index of the matrix A, and represents a specific layer of the key phrase, j is a column index of the matrix A, and represents a position in the current layer, z represents a specific parameter or position within a certain layer, usually used to indicate a detail or element within that layer, z may also be an identifier for a certain state or position, r represents a position or a state of a certain layer in the semantic network, and r refers to a position of a specific key phrase, used to determine its specific hierarchical or spatial position in the model,

Based on the four panic scenes of disaster events, medical disturbance events, stampedes, and terrorist attacks as case studies, a random survey is conducted. A total number of participants is 300, and the groups are divided as follows:
(1) Elderly group (under 60 years old): 62 people, including 29 males and 33 females;
(2) Middle-aged group (40 to 60 years old): 98 people, including 61 males and 37 females;
(3) Youth group (16 to 40 years old): 140 people, including 65 males and 75 females.

Statistical methods are used to optimize the survey results and weights. The weight information table is shown in Table 1.

TABLE 1
Statistics of weights of key phrases in the panic semantic model

| | Event | Key | | | | Event | Key | | |
|---|---|---|---|---|---|---|---|---|---|
| No. | type | phrase | Turnout | Weight | No. | type | phrase | Turnout | Weight |
| 1 | Medical | Kill | 152 | 0.51 | 2 | Stampede | Let me | 13 | 0.04 |
| | disturbance | | | | | | out | | |
| | event | | | | | | | | |
| 3 | Medical | Chop | 76 | 0.25 | 4 | Stampede | Don't | 32 | 0.11 |
| | disturbance | | | | | | push me | | |
| | event | | | | | | | | |
| 5 | Medical | Help | 21 | 0.07 | 6 | Stampede | Someone | 57 | 0.19 |
| | disturbance | | | | | | fell down | | |
| | event | | | | | | | | |
| 7 | Medical | Pay with | 38 | 0.13 | 8 | Stampede | Step on | 73 | 0.24 |
| | disturbance | one's life | | | | | someone | | |
| | event | | | | | | to death | | |
| 9 | Medical | Black heart | 2 | 0.01 | 10 | Stampede | It's | 53 | 0.18 |
| | disturbance | | | | | | crowded | | |
| | event | | | | | | to death | | |
| 11 | Medical | Act with utter | 7 | 0.02 | 12 | Stampede | Out of | 50 | 0.17 |
| | disturbance | disregard for | | | | | breath | | |
| | event | human life | | | | | | | |
| 13 | Medical | Misdiagnose | 4 | 0.01 | 14 | Stampede | Help | 22 | 0.07 |
| | disturbance | | | | | | | | |
| | event | | | | | | | | |
| 15 | Disaster | Landslide | 32 | 0.11 | 16 | Terrorist | Kidnapping | 42 | 0.14 |
| | event | | | | | attack | | | |
| 17 | Disaster | Earthquake | 57 | 0.19 | 18 | Terrorist | Explosion | 36 | 0.12 |
| | event | | | | | attack | | | |
| 19 | Disaster | Fire | 28 | 0.09 | 20 | Terrorist | Bomb | 48 | 0.16 |
| | event | | | | | attack | | | |
| 21 | Disaster | Debris flow | 23 | 0.08 | 22 | Terrorist | There's | 47 | 0.16 |
| | event | | | | | attack | a gun | | |
| 23 | Disaster | Flood and | 45 | 0.15 | 24 | Terrorist | Poison | 35 | 0.11 |
| | event | water-logging | | | | attack | gas | | |
| 25 | Disaster | Tornado | 42 | 0.14 | 26 | Terrorist | The dead | 26 | 0.09 |
| | event | | | | | attack | | | |
| 27 | Disaster | Tsunami | 73 | 0.24 | 28 | Terrorist | Kill | 66 | 0.22 |
| | event | | | | | attack | | | |

In S3, a weight of each of the key phrases is obtained according to the specific layer and the position of each of the key phrases using a description matrix of a panic semantic reasoning network model, and consistency matching is performed on a panic degree in a scene to determine whether the panic behavior occurs in the scene.

Specifically, the consistency matching is to compare the real-time recognized key phrases with the layered information in the panic semantic model, and calculate the weight of each phrase based on its layer and position. Then, the weights are compared with the set threshold. When the weighted result exceeds the threshold, the model determines that panic behavior has occurred; otherwise, it is determined that there is no panic behavior. This process ensures accurate identification of panic behavior through semantic strength and contextual matching of key phrases.

The establishment steps of the panic semantic reasoning network model are as follows.
(1) A panic scene is selected. Firstly, it is necessary to consider whether the panic scene is relatively common, and try to select scenes that occur frequently and are prone to panic, such as medical disturbance scenes, natural disaster scenes and crowded scenes. Secondly, whether the panic scene can be identified and prevented in advance is considered, and the establishment of the reasoning network model for such scene has more practical application value. Finally, whether there is sufficient data support for training and validation in the scene is considered.
(2) A basic concept in the selected panic scene is defined by using web ontology language (OWL), such as panic semantic expression is one of the sources of panic psychology, and panic psychology will induce panic behavior.
(3) The panic semantic model in the panic scene is improved, and the knowledge elements in the panic scene are supplemented, which includes the key phrases, crowd statuses and occurrence conditions.
(4) Corresponding reasoning rules are defined to make the model have reasoning ability. For example, during a crowded stampede event, when key phrases such as “out of breath”, “help”, “someone fell down” and “step on someone to death” are recognized, consistency determination will be performed with the panic degree in the scene based on the weight of each key phrase. When the panic degree in the scene exceeds a certain threshold, it is determined that panic behavior has occurred in the scene.

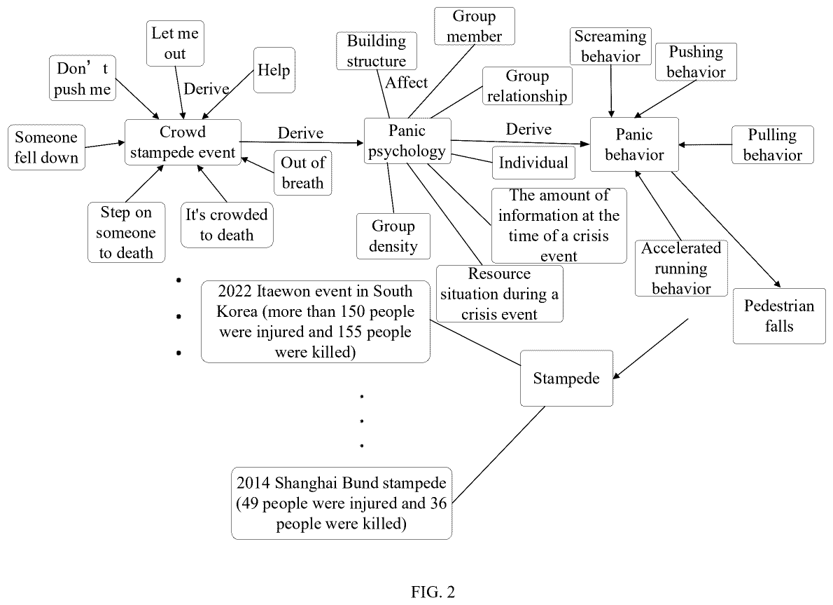

Specifically, the panic semantic reasoning network model is shown in FIG. 2.

The description matrix of the panic semantic reasoning network model is expressed as follows:

$$M = \{ {m}_{i , j} \} = \{ \begin{matrix}{m}_{{A}_{0}} & {ω}_{{A}_{1}} \\ {m}_{{A}_{1}} & {ω}_{{A}_{2}} \\ ⋮ & ⋮ \\ {m}_{{A}_{q - 1}} & {ω}_{{A}_{q - 1}} \\ {m}_{{A}_{q}} & {ω}_{{A}_{q}}\end{matrix} \} ;$$

where m_{A}_{_{q}} represents location information of a (q+1)^{th} key phrase, ω_{A}_{_{q}} represents a weight of the (q+1)^{th} key phrase=, and

$${\sum }_{1}^{q} {ω}_{{A}_{q}} = 1.$$

For example, assuming that two key phrases are extracted through speech recognition in an emergency evacuation scene, including: “escape route” and “run fast”. According to the panic semantic reasoning network, the two phrases are assigned to different layers. For example, “escape route” may belong to a layer 0 and be at a position m_{A}_{₀}, while “run fast” belongs to a layer 1 and is at m_{A}_{₁}. At the same time, each phrase is assigned different weights based on its impact on panic behavior, for example, the weight of “escape route” is 0.7, while the weight of “run fast” is 0.3. According to the formula

$${\sum }_{1}^{q} {ω}_{{A}_{q}} = 1 ,$$

the sum of these weights is 1. The model calculates the weighted values of the key phrases, and when their weighted sum exceeds a certain threshold (such as 0.8), it is determined as panic behavior; when it does not exceed, it is considered that there is no panic behavior. This process utilizes the positional information and weights of each phrase to help the model identify and determine the occurrence of panic events in actual scene.

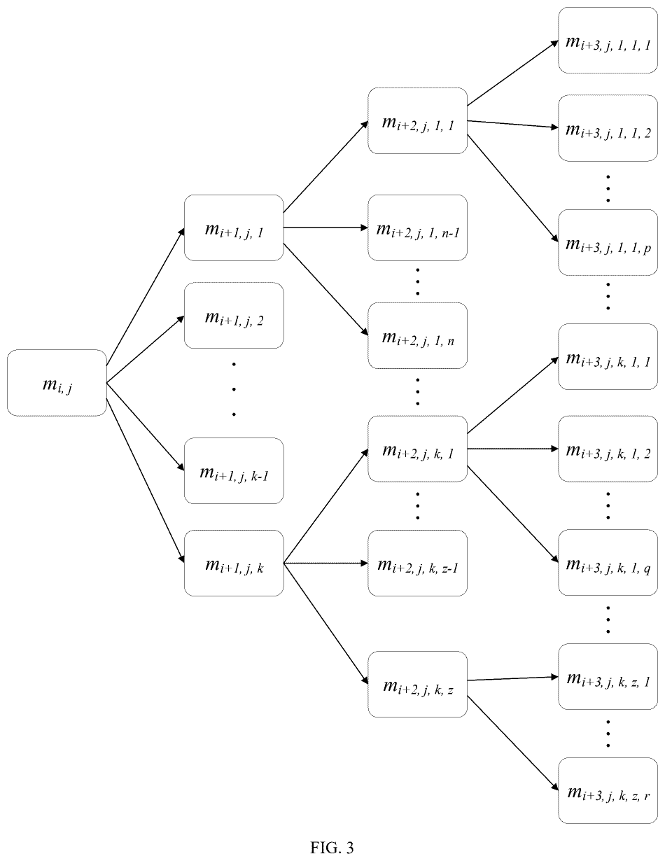

A derivation logic diagram of the description matrix of the panic semantic reasoning network model is shown in FIG. 3.

A matching result of the panic semantic reasoning network model is as follows:

$$γ ∈ ( 0 , 1 ) ;$$

where γ represents the matching result of the panic semantic reasoning network model.

In an embodiment, when the panic semantic reasoning network model matches with the key phrases related to panic and a weighted structure exceeds the threshold, a matching result of the panic semantic reasoning network model is γ=1; otherwise, γ=0.

In the embodiment, the key phrases such as “chop” are recognized, the panic semantic reasoning network model determines the specific layer and position of each key phrase in the panic semantic reasoning network model according to the position coordinate matrix. The effect of each key phrase on the panic degree of the scene is calculated according to the weight information provided by the description matrix, and the key phrases with large weights have larger effect on the determination of the panic scene. The current scene is reasoned and determined by combining the weights of multiple key phrases and the reasoning rules, the system simultaneously matches multiple key phrases with high weight, which reach the threshold. The matching result of the panic semantic reasoning network model is γ=1, which can determine that the input video exists the panic behavior.

### Embodiment 2

The embodiment provides a non-transitory computer-readable storage medium, the non-transitory computer-readable storage medium is stored with a computer program, and the computer program is configured to, when is executed by a processor, implement the method for recognizing the panic behavior based on panic semantic analysis.

The rest are the same as the embodiment 1.

### Embodiment 3

The embodiment provides a system for recognizing panic behavior based on panic semantic analysis, including an audio data acquisition module, a key phrase recognition module, a layered position module, a panic behavior determination model, a data display module, and an alarm prompt module.

The audio data acquisition module is configured to collect audio data in the environment in real-time, and transmit the collected audio streaming to the key phrase recognition module for subsequent processing.

The key phrase recognition module is configured to call an AI interface to recognize the audio streaming as semantic information in real-time, and perform, based on the semantic information and a basic concept, layered division to recognize key phrases in the semantic information.

The layered position module is configured to determine a specific layer and a position of each of the key phrases in a panic semantic model according to a position coordinate matrix.

The panic behavior determination model is configured to obtain a weight of each of the key phrases according to the specific layer and the position of each of the key phrases using a description matrix of a panic semantic reasoning network model, and perform consistency matching on a panic degree in a scene to determine whether the panic behavior occurs in the scene.

The data display module is configured to visually display the recognition results of the panic behavior and related data to users for real-time monitoring and subsequent analysis.

The alarm prompt module is configured to integrate alarm prompt function in the data display module, when the system detects the panic behavior, it can promptly remind relevant personnel through visual (text) and auditory (sound) means.

In an exemplary embodiment, each of the audio data acquisition module, the key phrase recognition module, the layered position module, the panic behavior determination model, the data display module, and the alarm prompt module is embedded by at least one processor and at least one memory coupled to the at least one processor, and the at least one memory stores computer programs executable by the at least one processor.

An overall execution process of the system is as follows. The audio data acquisition module captures environment audio in real-time through a microphone device. The key phrase recognition module receives the audio streaming, converts the audio streaming into text semantic information through the AI interface, and recognizes the key phrases. The layered position module determines the specific layer and position of each key phrase in the panic semantic model according to the position coordinate matrix. The panic behavior determination model calculates the weight of each key phrase, performs consistency matching, and determines whether the panic behavior occurs. The data display module visually displays the recognition results to users, and provides real-time monitoring and alarming functions. When the panic behavior determination model detects a high-risk panic behavior, the alarm prompt module promptly alerts through sound and visual means.

The establishment steps of the panic semantic reasoning network model are as follows.

A panic scene is selected as a description object.

A basic concept in the selected panic scene is defined by using OWL.

The knowledge elements in the panic scene are supplemented to improve the panic semantic model in the panic scene.

Reasoning rules are defined based on the panic semantic model in the panic scene to establish the panic semantic reasoning network model with a panic semantic analysis ability and a panic event reasoning ability.

The rest are the same as the embodiment 1.

What is claimed is:

1. A method for recognizing panic behavior based on panic semantic analysis, comprising:
calling an artificial intelligence (AI) interface to recognize audio streaming as semantic information in real-time, and performing, based on the semantic information and a basic concept, layered division to recognize key phrases in the semantic information;
determining a specific layer and a position of each of the key phrases in a panic semantic model according to a position coordinate matrix; and
obtaining a weight of each of the key phrases according to the specific layer and the position of each of the key phrases using a description matrix of a panic semantic reasoning network model, and performing consistency matching on a panic degree in a scene to determine whether the panic behavior occurs in the scene;
wherein establishment steps of the panic semantic reasoning network model comprise:
selecting a panic scene as a description object;
defining a basic concept in the panic scene by using a web ontology language;
supplementing knowledge elements in the panic scene to improve a panic semantic model in the panic scene; and
defining, based on the panic semantic model in the panic scene, reasoning rules to establish the panic semantic reasoning network model with a panic semantic analysis ability and a panic event reasoning ability.

2. The method for recognizing panic behavior based on panic semantic analysis as claimed in claim 1, wherein the semantic information comprises shouting, cries for help and conversation content in crowds.

3. The method for recognizing panic behavior based on panic semantic analysis as claimed in claim 1, wherein the panic scene comprises medical disturbance scenes, natural disaster scenes and crowded scenes.

4. The method for recognizing panic behavior based on panic semantic analysis as claimed in claim 1, wherein the knowledge elements in the panic scene comprise the key phrases, crowd statuses and occurrence conditions.

5. The method for recognizing panic behavior based on panic semantic analysis as claimed in claim 1, wherein the position coordinate matrix is expressed as follows:
$$A = \{ {a}_{( q + 1 ) \times {col}_{r}} \} = \{ \begin{matrix}i , j , … , z , r \\ i , j , … , z , r + 1 \\ ⋮ \\ i , j , … , z , r + q\end{matrix} \} = \{ \begin{matrix}{A}_{0} \\ {A}_{1} \\ ⋮ \\ {A}_{q}\end{matrix} \} ;$$
where i=colᵣ−1, colᵣ represents a total length of each of the key phrases, Aᵢ represents key phrases that have a same total length but are different in a last layer, q+1 represents a total number of keywords in a layer where each of the key phrase is located.

6. The method for recognizing panic behavior based on panic semantic analysis as claimed in claim 1, wherein the description matrix of the panic semantic reasoning network model is expressed as follows:
$$M = \{ {m}_{i , j} \} = \{ \begin{matrix}{m}_{{A}_{0}} & {ω}_{{A}_{1}} \\ {m}_{{A}_{1}} & {ω}_{{A}_{2}} \\ ⋮ & ⋮ \\ {m}_{{A}_{q - 1}} & {ω}_{{A}_{q}} \\ {m}_{{A}_{q}} & {ω}_{{A}_{q + 1}}\end{matrix} \} ;$$
wherein m_{A}_{_{q}} represents position information of a (q+1)^{th} key phrase, WA, represents a weight of the (q+1)^{th} key phrase, and
$${\sum }_{1}^{q} {ω}_{{A}_{q}} = 1.$$

7. The method for recognizing panic behavior based on panic semantic analysis as claimed in claim 6, wherein the description matrix comprises key phrase information and weight information.

8. The method for recognizing panic behavior based on panic semantic analysis as claimed in claim 1, wherein, when the panic semantic reasoning network model matches with key phrases related to panic and a weighted structure exceeds a threshold, a matching result of the panic semantic reasoning network model is γ=1; otherwise, γ=0.

9. A non-transitory computer-readable storage medium, wherein the non-transitory computer-readable storage medium is stored with a computer program, and the computer program is configured to, when is executed by a processor, implement the method for recognizing the panic behavior based on panic semantic analysis as claimed in claim 1.

10. A system for recognizing panic behavior based on panic semantic analysis, comprising:
a key phrase recognition module, configured to call an AI interface to recognize audio streaming as semantic information in real-time, and perform, based on the semantic information and a basic concept, layered division to recognize key phrases in the semantic information;
a layered position module, configured to determine a specific layer and a position of each of the key phrases in a panic semantic model according to a position coordinate matrix; and
a panic behavior determination model, configured to obtain a weight of each of the key phrases according to the specific layer and the position of each of the key phrases using a description matrix of a panic semantic reasoning network model, and perform consistency matching on a panic degree in a scene to determine whether the panic behavior occurs in the scene;
wherein establishment steps of the panic semantic reasoning network model comprise:
selecting a panic scene as a description object;
defining a basic concept in the panic scene by using a web ontology language;
supplementing knowledge elements in the panic scene to improve a panic semantic model in the panic scene; and
defining, based on the panic semantic model in the panic scene, reasoning rules to establish the panic semantic reasoning network model with a panic semantic analysis ability and a panic event reasoning ability.
